(19) United States
(12) Patent Application Publication
(10) Pub. No.: US 2005/0038739 A1
(43) Pub. Date: Feb. 17, 2005

(54) Methods of processing payment in an electronic commercial transaction and a payment consolidator therefor

(75) Inventors: Wayne M. Doran, Kitchener (CA); Douglas J. McLean, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 10/640,087

(22) Filed: Aug. 13, 2003

(51) Int. Cl. G06F 17/60

(52) U.S. Cl. 705/40

(57) ABSTRACT

A method of processing payment in an electronic commercial transaction between a buyer and a seller comprises receiving payment from the buyer according to a first payment method pre-selected by the buyer, and making payment to the seller according to a second payment method pre-selected by the seller. The first payment method pre-selected by the buyer and the second payment method pre-selected by the seller are different from each other. Another method of making payment to a seller in an electronic commercial transaction comprises paying the seller according to a first payment method when the amount of the transaction is less than a predetermined amount, and paying the seller according to a second payment method which is different from the first payment method when the amount of the transaction is greater than the predetermined amount. The first and second payment methods may be pre-selected by the seller.

### BACKGROUND OF THE INVENTION

The present invention relates to electronic commercial transactions, and is particularly directed to methods of processing payment in an electronic commercial transaction and a payment consolidator therefor.

In a typical electronic commercial transaction between a buyer and a seller of goods, the buyer makes payment to the seller using a payment method which is supported by the seller. Examples of payment methods include credit, debit, or check. The seller may support all payment methods used by their buyers. In this case, a hardship is imposed on the seller since the seller must procure all necessary hardware and software to support all payment methods. Alternatively, the seller may restrict buyers to only a particular set of payment methods that can be accepted. In this latter case, a hardship is imposed on some buyers since these buyers may not have capability to make payment to the seller using a payment method acceptable to the seller. In either case, a potential electronic commercial transaction between a buyer and a seller may not occur, especially if the seller is unable to support a preferred payment method of the buyer.

### SUMMARY OF THE INVENTION

In accordance with one aspect of the present invention, a method of processing payment in an electronic commercial transaction between a buyer and a seller comprises receiving payment from the buyer according to a first payment method pre-selected by the buyer, and making payment to the seller according to a second payment method pre-selected by the seller. The first payment method pre-selected by the buyer and the second payment method pre-selected by the seller are different from each other.

In accordance with another aspect of the present invention, a method of making payment to a seller in an electronic commercial transaction comprises paying the seller according to a first payment method when the amount of the transaction is less than a predetermined amount, and paying the seller according to a second payment method which is different from the first payment method when the amount of the transaction is greater than the predetermined amount. The first and second payment methods may be pre-selected by the seller.

In accordance with yet another aspect of the present invention, a payment consolidator is provided for processing payment in an electronic commercial transaction between a buyer and a seller. The payment consolidator comprises a first storage device for storing a first payment method pre-selected by the buyer, a second storage device for storing a second payment method pre-selected by the seller, means for receiving payment from the buyer according to the first payment method pre-selected by the buyer, and means for making payment to the seller according to the second payment method pre-selected by the seller. The first payment method pre-selected by the buyer and the second payment method pre-selected by the seller are different from each other.

In accordance with still another aspect of the present invention, a payment consolidator is provided for making payment to a seller in an electronic commercial transaction. The payment consolidator comprises a first storage device for storing a first payment method, a second storage device for storing a second payment method, means for paying the seller according to the first payment method when the amount of the transaction is less than a predetermined amount, and means for paying the seller according to the second payment method which is different from the first payment method when the amount of the transaction is greater than the predetermined amount. The first and second payment methods may be pre-selected by the seller.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a block diagram of a payment system embodying the present invention;

FIG. 2 is an enlarged portion of the block diagram of FIG. 1;

FIG. 3 is a flowchart depicting a payment method in accordance with the present invention; and

FIG. 4 is a flowchart depicting another payment method in accordance with the present invention

### DETAILS OF THE INVENTION

The present invention relates to electronic commercial transactions, and is particularly directed to methods of processing payment in an electronic commercial transaction and a payment consolidator therefor.

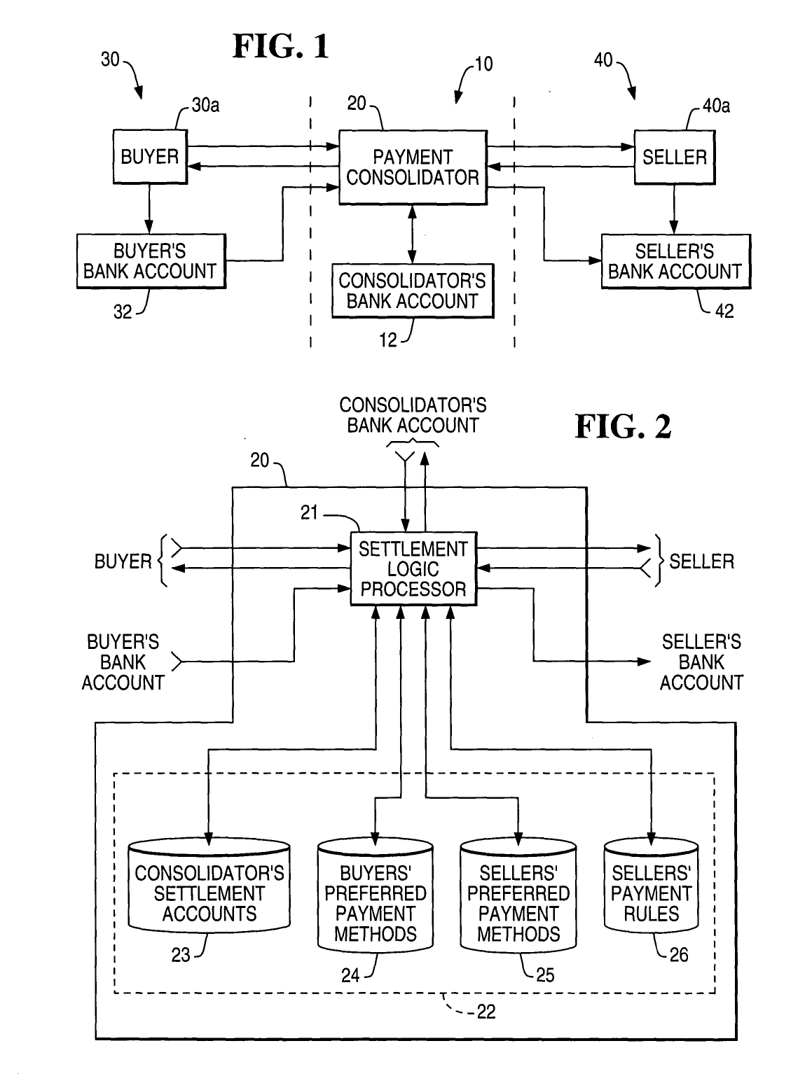

Referring to FIG. 1, a third party consolidator 10 acts as intermediary between a number of buyers 30 and a number of sellers 40. For simplicity, only one buyer 30a and only one seller 40a are shown in FIG. 1. The buyer 30a has a bank account 32 from which monies can be transferred to pay for goods purchased by the buyer in an electronic commercial transaction between the buyer and the seller 40a. The seller 40a has a bank account 42 to which monies can be transferred to receive payment for goods sold by the seller in the electronic commercial transaction. The third party consolidator 10 has a bank account 12 to which monies received from the buyer 30a can be transferred and from which monies to be paid to the seller 40a can be transferred, as will be described in more detail later.

Referring to FIGS. 1 and 2, the third party consolidator 10 has a payment consolidator 20, preferably in the form of a server, for supporting payment from the buyer 30a to the seller 40a for goods sold by the seller to the buyer in the electronic commercial transaction. The payment consolidator 20 includes a settlement logic processor 21 and memory 22 which stores, inter alia, settlement accounts 23 held by the third party consolidator 10 for each buyer and each seller registered with the third party consolidator. The memory 22 also stores preferred payment methods 24 of the buyers registered with the third party consolidator 10, and preferred payment methods 25 of sellers registered with the third party consolidator. The memory 22 also stores payment rules 26 for each of the sellers registered with the third party consolidator 10. Although the elements 23, 24, 25, 26 are shown stored in one memory 22, it is contemplated that these elements may be stored in more than one memory. These elements may be physically located at one facility or any number of different facilities. Suitable microcomputers and memories are readily available in the marketplace. Their structure and operation are well known and, therefore, will not be described.

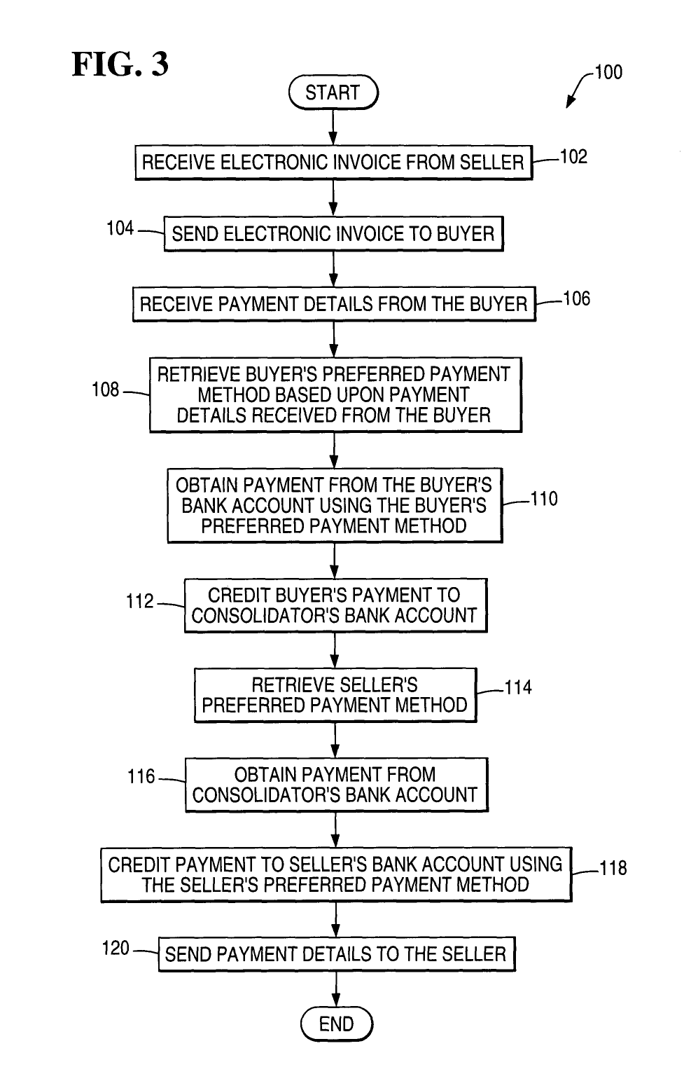

Referring to FIG. 3, a flowchart 100 depicts a payment method in an electronic commercial transaction carried out between the buyer 30a and the seller 40a. In steps 102 and 104, the processor 21 receives an electronic invoice from the seller 40a, and sends it to the buyer 30a. It is contemplated that steps 102 and 104 may not be performed by the processor 21, but rather outside of the processor. At a later time, the processor 21 receives payment details from the buyer 30a as shown in step 106. Payment details may include buyer name, invoice number, merchandise description, payment amount, purchase date, and the like.

Based upon payment details received from the buyer 30a, the processor 21 retrieves the particular buyer's (in this case the buyer 30a) preferred payment method from the memory 24 which stores preferred payment methods of all buyers pre-registered with the third party consolidator 10. The processor 21 obtains the payment amount from the bank account of the buyer 30a, as shown in step 110, and then credits the payment amount to the bank account of the third party consolidator 10, as shown in step 112.

After crediting the bank account of the third party consolidator 10, the processor 21 retrieves the particular seller's (in this case the seller 40a) preferred payment method from the memory 25 which stores preferred payment methods of all sellers pre-registered with the third party consolidator 10. The processor 21 withdraws the payment amount from the bank account of the third party consolidator 10, as shown in step 116, and then credits the payment amount to the bank account of the seller 40a, as shown in step 118.

After crediting the bank account of the seller 40a, the processor 21 sends payment details to the seller. Payment details may include buyer name, invoice number, merchandise description, payment amount, purchase date, etc. The third party consolidator 10 maintains the settlement accounts stored in the memory 23 for purpose of settling and reconciling individual transactions. The payment consolidator 20 acts to maintain a net zero balance in the settlement accounts. The third party consolidator 10 may charge a fee to either the buyer 30a or the seller 40a, or both, for each transaction. The third party consolidator 10 may also combine a plurality of different payments into a single payment to be made to the seller 40a. It should be apparent that by having electronic invoices sent from the seller 40a to the buyer 30a via the payment consolidator 20, as shown in steps 102, and 104 in FIG. 3, the third party consolidator 10 is able to reconcile payment, invoices, and the like, as a service to the seller.

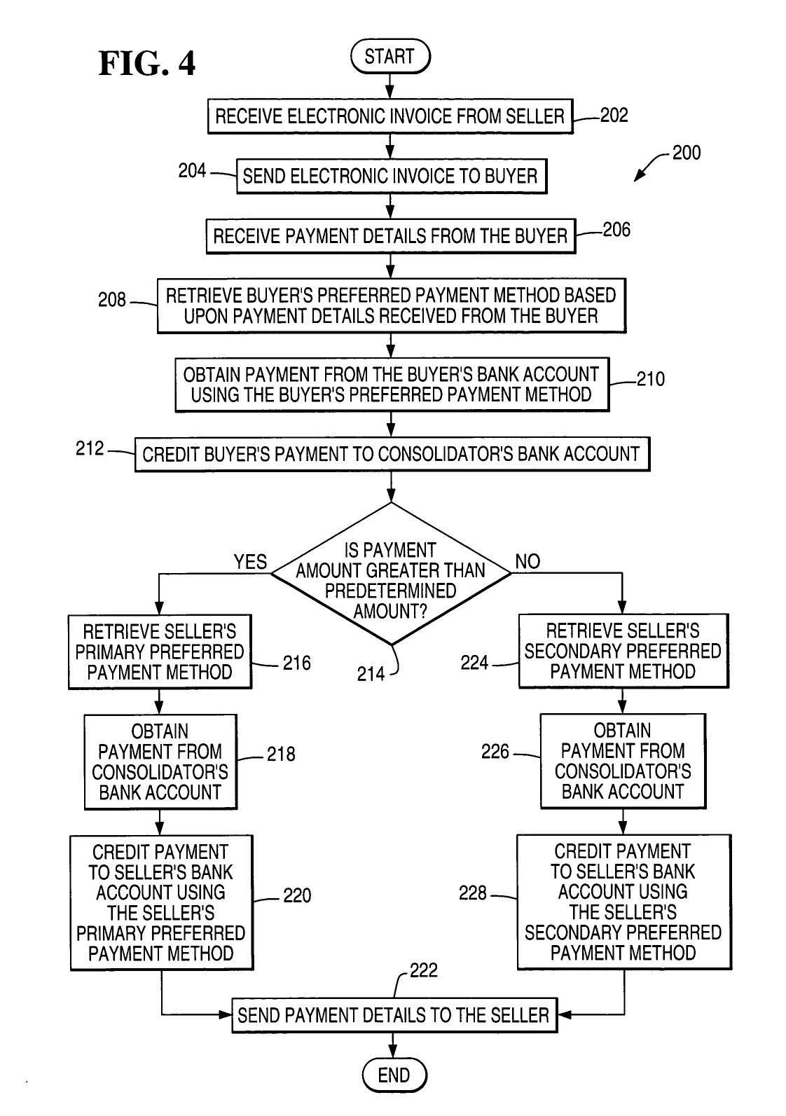

Referring to FIG. 4, a flowchart 200 depicts another payment method in an electronic commercial transaction carried out between the buyer 30a and the seller 40a. In steps 202 and 204, the processor 21 receives an electronic invoice from the seller 40a, and sends it to the buyer 30a. It is contemplated that steps 202 and 204 may not be performed by the processor 21, but rather outside of the processor. At a later time, the processor 21 receives payment details from the buyer 30a as shown in step 206. Payment details may include buyer name, invoice number, merchandise description, payment amount, purchase date, and the like.

Based upon payment details received from the buyer 30a, the processor 21 retrieves the particular buyer's (in this case the buyer 30a) preferred payment method from the memory 24 which stores preferred payment methods of all buyers pre-registered with the third party consolidator 10. The processor 21 obtains the payment amount from the bank account of the buyer 30a, as shown in step 210, and then credits the payment amount to the bank account of the third party consolidator 10, as shown in step 212.

After crediting the bank account of the third party consolidator 10, a determination is made in step 214 as to whether the amount of the payment is greater than a predetermined amount. This predetermined amount may be pre-selected by the particular seller (in this case the seller 40a), and is preferably stored as a payment rule in the memory 26. The memory 26 stores payment rules associated with all sellers pre-registered with the third party consolidator 10.

If the determination in step 214 is affirmative, the processor 21 retrieves the seller's primary payment method from the memory 25 which stores preferred payment methods of all sellers pre-registered with the third party consolidator 10, as shown in step 216. The processor 21 withdraws the payment amount from the bank account of the third party consolidator 10, as shown in step 218, and then credits the payment amount to the bank account of the seller 40a using the seller's primary preferred payment method, as shown in step 220. Payment details are then sent to the seller 40, as shown in step 222.

However, if the determination in step 214 is negative, the processor 21 retrieves the seller's second payment method which is also stored in the memory 25, as shown in step 224. The seller's second payment method is different from the seller's primary payment method described hereinabove in connection with step 216. The processor 21 withdraws the payment amount from the bank account of the third party consolidator 10, as shown in step 226, and then credits the payment amount to the bank account of the seller 40a using the seller's secondary preferred payment method, as shown in step 228. Payment details are then sent to the seller 40, as shown in step 222.

A number of advantages may result by providing a payment system and methods of processing a payment in accordance with the present invention. One advantage is that each buyer is allowed to make payment in a payment method of the buyer's choice, and each seller is allowed to receive payment in a payment method of the seller's choice. This facilitates convenience and ease for each buyer and each seller in carrying out an electronic commercial transaction. Each buyer and each seller can independently use the single payment method of his/her choice in an electronic commercial transaction. Since each buyer or seller need only support one payment method, the costs to process payment are reduced, reconciliation is made easier, and record keeping is made easier.

Another advantage is that a seller can receive payment in a first preferred payment method when predetermined criteria is met, and receive payment in a second preferred payment method which is different from the first preferred payment method when the predetermined criteria is not met.

Still another advantage is that potential transactions that might not otherwise occur between a buyer and a seller are accommodated. For example, when a relationship does exist between a buyer and a seller, a potential transaction may not occur. However, a potential transaction which might not otherwise occur would be accommodated by providing a payment method in accordance with the present invention.

Yet another advantage is that each buyer and each seller do not have to negotiate payment methods with each other on each transaction. Each buyer and each seller need only register once with the third party consolidator 10 indicating the preferred payment method. After initial registration, only changes need to be registered. In addition, each buyer and each seller do not have to obtain new agreements with each other when either party desires to use a new payment method. Only the third party consolidator 10 is required to support the new payment method.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A method of processing payment in an electronic commercial transaction between a buyer and a seller, the method comprising:
receiving payment from the buyer according to a first payment method pre-selected by the buyer; and
making payment to the seller according to a second payment method pre-selected by the seller.

2. A method according to claim 1, wherein the first payment method pre-selected by the buyer and the second payment method pre-selected by the seller are different from each other.

3. A method of making payment to a seller in an electronic commercial transaction, the method comprising:
paying the seller according to a first payment method when the amount of the transaction is less than a predetermined amount; and
paying the seller according to a second payment method which is different from the first payment method when the amount of the transaction is greater than the predetermined amount.

4. A method according to claim 3, wherein the first and second payment methods are pre-selected by the seller.

5. A payment consolidator for processing payment in an electronic commercial transaction between a buyer and a seller, the payment consolidator comprising:
a first storage device for storing a first payment method pre-selected by the buyer;
a second storage device for storing a second payment method pre-selected by the seller;
means for receiving payment from the buyer according to the first payment method pre-selected by the buyer; and
means for making payment to the seller according to the second payment method pre-selected by the seller.

6. A payment consolidator according to claim 5, wherein the first payment method pre-selected by the buyer and the second payment method pre-selected by the seller are different from each other.

7. A payment consolidator for making payment to a seller in an electronic commercial transaction, the payment consolidator comprising:
a first storage device for storing a first payment method;
a second storage device for storing a second payment method;
means for paying the seller according to the first payment method when the amount of the transaction is less than a predetermined amount; and
means for paying the seller according to the second payment method which is different from the first payment method when the amount of the transaction is greater than the predetermined amount.

8. A payment consolidator according to claim 7, wherein the first and second payment methods are pre-selected by the seller.
